(19) United States
(12) Patent Application Publication
(10) Pub. No.: US 2011/0215889 A1
(43) Pub. Date: Sep. 8, 2011

(54) Stabilized ball bearings for camera lens

(75) Inventor: Ernst Schworm, Munich (DE)

(73) Assignee: Digital Imaging Systems GmbH

(21) Appl. No.: 12/660,870

(22) Filed: Mar. 5, 2010

(51) Int. Cl. H01F 7/02

(52) U.S. Cl. 335/285

(57) ABSTRACT

Systems and methods are disclosed for cameras using ball bearings to guide the movements of movable parts as e.g. a lens barrel wherein the repulsive force of magnets is used to hold the ball bearings together an hence the movable parts in place in case of a mechanical shock. In a first embodiment of the invention the magnets and the ball bearings are on a same side of the lens barrel. In a second embodiment of the invention the magnets and the ball bearings are on an opposite side of the lens barrel. Furthermore a camera has been disclosed wherein the shutter is moved by a linear motor and an integrated circuit controls the motor moving the shutter and the actuators moving the lens barrel.

### RELATED APPLICATIONS

This application is related to the following U.S. patent applications:
DI09-003/004, titled “Camera Module having a low-friction movable lens”, Ser. No. ______, filing date ______.
DI08-004, titled “Camera Shutter”, Ser. No. ______, filing date ______.
DI08-006, titled “Camera Shutter and position control thereof”, Ser. No. 12/658,280, filing date Feb. 5, 2010, and
DI09-007, titled “Twin-actuator configuration for a camera module”, Ser. No. ______, filing date ______.
and the above applications are herein incorporated by reference in their entirety.

### BACKGROUND OF THE INVENTION

(1) Field of the Invention

This invention relates generally to ball bearings and relates more specifically to using magnets to hold ball bearings between a fixed and moving part together.

(2) Description of the Prior Art

Ball bearings, used with appliances as e.g. cameras, allow movements of components requiring a minimum of power consumption due to very low friction of the ball bearings. In prior art often mechanical devices are used to hold ball bearings together in shock conditions. For small appliances that would require a very tight mechanical backup, such as e.g. cameras, these mechanical devices are difficult to achieve due to small dimensions and tolerances. Alternatively magnetic attracting force has been used to prevent balls to fall out in case of a heavy shock. The disadvantage of using magnetic attractive force is that magnet's attractive force is decreasing rapidly with increasing distance between the magnet and the ball bearing.

It is a challenge for the designers of small appliances such as cameras using ball bearings to hold these ball bearings firmly together under shock conditions.

Solutions dealing with ball bearings are described in the following patents:

U.S. Patent (U.S. Pat. No. 4,598,989 to Yamada et al.) teaches an automatic focusing camera comprising: a distance measuring means, a cylindrical permanent magnet means which is provided fixedly inside of the lens barrel, a cylindrical moving coil member which is concentric with said cylindrical permanent means, a lens unit which is driven together with the cylindrical moving coil member, and a spring for urging said lens unit to the most frequently employed focusing point of its traveling range, wherein the lens unit is adapted to move to a point corresponding to an output signal from the distance measuring means under the influence of the cylindrical moving coil member.

U. S. Patent (U.S. Pat. No. 4,304,463 to Tomori) discloses a lens barrel automatic focalization device for a camera in which the camera body furnishes a focalization operational force in which the rotational resistance force produced by the focalization operation is made constant over various lenses so that the response time of the focalization operation is made uniform. The camera body includes a mount and a rotary member rotatably mounted on the camera body on a shaft perpendicular to the optical axis of the camera at the lower center portion of the mount. The focalization device includes a rotary member positioned so as to be rotatable by the rotary member of the camera body with the rotational force of the rotary member being coupled to a rotary cylinder having threads engaged with the threads of a movable sleeve or cylinder. The rotary cylinder is mounted within a stationary cylinder with ball bearings being provided therebetween. Rotational movement of the movable cylinder is restrained by a regulating cylinder fixed to the supporting cylinder and having guide pins which extend into corresponding longitudinal guide slots on the outer surface of the moving cylinder.

U. S. Patent (U.S. Pat. No. 6,922,315 to Berthaud et al.) discloses a first aspect the invention related to a head drum arrangement allowing a much easier mounting of the rotary transformer. The head drum arrangement comprises a non-rotating lower drum and a rotating upper drum, which are connected by a shaft fixed in the lower drum. The upper drum is mounted on the shaft by a bearing and preferably by two ball bearings. A rotary transformer is arranged between the lower drum and the upper drum having a fixed stator and a rotor rotating jointly with the upper drum. The rotor is non-positively held in its position by the magnetic force of a permanent magnet accommodated in the upper drum.

### SUMMARY OF THE INVENTION

A principal object of the present invention is to hold movable parts guided by ball bearings in place in case of a mechanical shock.

Another principal object of the present invention is to hold movable parts of a camera in place in case of a mechanical shock, wherein the movable parts are guided by ball bearings.

A further object of the present invention is to hold movable parts guided by ball bearings in place in case of a mechanical shock without consuming electrical power.

A further object of the present invention is to hold movable parts guided by ball bearings in place in case of a mechanical shock.

A further object of the present invention is to hold balls of ball bearings in place in case of a mechanical shock.

A further object of the invention is to use the repulsive force of magnets to hold the balls in place

A further object of the invention is to hold balls of ball bearings in place in case of a mechanical shock, wherein the ball bearings are used to guide a lens barrel of a camera.

In accordance with the objects of this invention a method for cameras to hold movable parts of the camera in place in case of a mechanical shock has been achieved. The method invented comprises the following steps: (1) providing a camera module comprising movable parts having their movements guided by ball bearings, (2) using repulsive force of said one or more pairs of magnets in order to push the movable parts onto their ball bearings, and (3) deploying said one or more pairs of magnets in a way that from each pair of magnets a first magnet is located on a fixed part of the camera and a second magnet is located oppositely on the movable part, wherein both magnets of a pair have a same magnetic polarity on their neighboring sides and are suitably located to push the movable part onto related ball bearings and hence preventing balls of the ball bearings to fall out and holding the movable parts in place.

In accordance with the objects of this invention a camera capable of holding movable parts of the camera in place in case of a mechanical shock has been achieved. The camera invented comprises, firstly, an image sensor, a shutter with an aperture function driven by a linear motor, and said motor driving the shutter, wherein the motor has an integrated position sensing system. Furthermore the camera comprises a movable lens barrel, at least two actuators to move said lens barrel, and an integrated circuit controlling the motor driving the shutter and the actuators moving the lens barrel. Finally the camera comprises a first and a second magnet, wherein the first magnet is fastened on the moving lens barrel and the second magnet is deployed oppositely to the first magnet on a fixed part of the camera and wherein the first and the second magnets have a same magnetic polarity on their neighboring sides, hence pushing the lens barrel onto ball bearings, and said ball bearings, wherein the balls of each ball bearing are moving between the lens barrel and a fixed part of the camera.

In accordance with the objects of this invention a camera capable of holding movable parts of the camera in place in case of a mechanical shock has been achieved. The camera invented comprises: a movable lens barrel, a first and a second magnet, wherein the first magnet is fastened on the moving lens barrel and the second magnet is deployed oppositely to the first magnet on a fixed part of the camera and wherein the first and the second magnets have a same magnetic polarity on their neighboring sides, hence pushing the lens barrel onto ball bearings, and said ball bearings wherein the balls of each ball bearing are moving between the lens barrel and a fixed part of the camera.

### BRIEF DESCRIPTION OF THE DRAWINGS

In the accompanying drawings forming a material part of this description, there is shown:

FIG. 1 illustrates a cross view of a first embodiment of the present invention, having pushing magnets and ball bearings on the same side of a moving lens barrel.

FIG. 2 illustrates a cross view of a second embodiment of the present invention, having pushing magnets and ball bearings on opposite sides of a moving lens barrel.

FIG. 3 shows an oblique 3-dimensional view of a camera module according to the second embodiment of the present invention

FIG. 4 illustrates a flowchart of a method for cameras to hold together ball bearings used to guide a movable part in order to prevent balls falling out in case of a shock.

### DESCRIPTION OF THE PREFERRED EMBODIMENTS

Systems and methods for holding together ball bearings have been achieved. In a preferred embodiment of the invention ball bearings used to move a lens barrel of a camera are to be held together in order to prevent balls falling out in case of a mechanical shock. It should be noted that the invention could be used with a multitude of other applications, especially for mobile appliances, which can be exposed to shock conditions. A key item of the invention is that repulsive magnetic force is used to keep the ball bearing together. A main advantage of the invention is that magnetic repulsion force is increasing dramatically with an increasing distance between a fixed and moving part of the ball bearing. Furthermore it should' be noted that not only the balls of ball bearings but also the lens barrel and other moving objects of the camera as e.g. a shutter system are held in place

Preferred embodiments of the invention are using more than one actuator to move a lens barrel of the camera. In the preferred embodiments of the invention actuators with integrated position detection are used to drive the movable lens barrel and to control an actual position of the lens barrel, e.g. as disclosed in the patent application DI09-003/004, titled “Camera Module having a low-friction movable lens”, Ser. No. ______, filing date ______ and as disclosed in the patent application DI08-004, titled “Camera Shutter” Ser. No. ______, filing date ______. Other motors having a position control could be used as well.

While the preferred embodiment of the invention uses linear movements of a lens barrel it should be noted that the invention could be applied also for rotational movements.

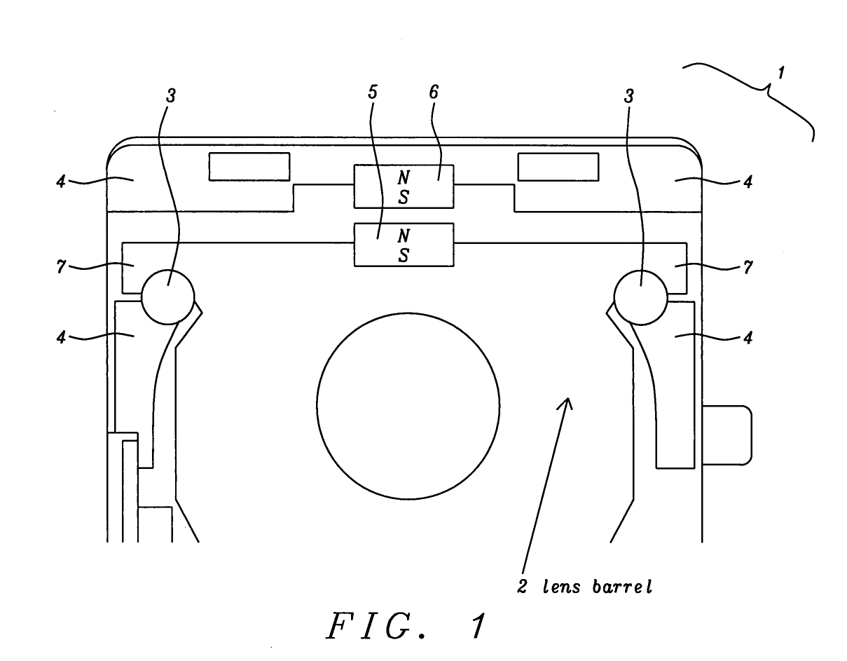

FIG. 1 illustrates a cross view of a first embodiment of the present invemtion. It shows a camera module 1, wherein a lens barrel 2 can be moved using balls 3 of ball bearings. The lens barrel 2 can be moved to a focus position, e.g. by a motor of an autofocus system, along an optical axis of the camera, which is from or to the viewer of FIG. 1. The balls 3 are moving between a moving part, i.e. the lens barrel 2, and a fixed part 4 of the camera 1. Optional ball cages can be used to guide the balls of the ball bearings.

A first “pushing” magnet 5 is fastened on the moving lens barrel 2 and a second “pushing” magnet 6 is deployed oppositely to the first magnet 5 on a fixed part 4 of the camera 1. Both magnets 5 and 6 are on the same side of the lens barrel 2 as the balls 3. Both magnets have a same magnetic polarity on their neighboring sides; therefore the repulsive magnetic force of both magnets 5 and 6 pushes the movable lens barrel via “wings” 7 onto the balls 3 of the ball bearings. In case of a mechanical shock, causing a potential movement of the lens barrel 2 away from the balls 4, the distance between the two magnets 5 and 6 gets smaller and the repulsive force of the magnets increases hyperbolically with the diminishing distance between both magnets 5 and 6 and pushing instantenously the lens barrel 2 back. This illustrates the advantage of using the repulsive magnetic force rather than the attractive magnetic force to hold the moving and fixed parts of the ball bearings together.

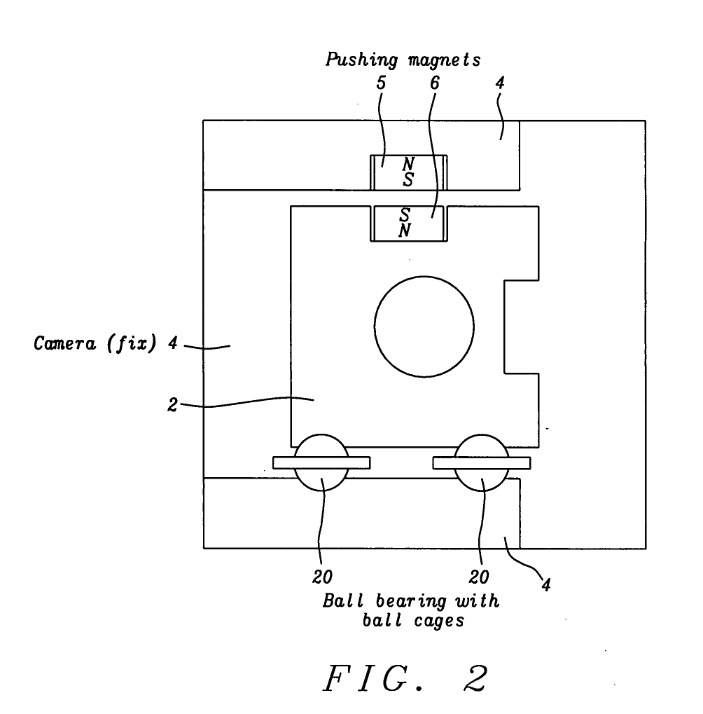

FIG. 2 illustrates a cross view of a second embodiment of the present invemtion. It shows also a camera module 1, wherein a lens barrel 2 can be moved using balls 20, having ball cages, of ball bearings. The lens barrel 2 can be moved to a focus position, e.g. by a motor of an autofocus system, along an optical axis of the camera, which is from or to the viewer of FIG. 2. The balls 20 are moving between a moving part, i.e. the lens barrel 2, and a fixed part 4 of the camera 1.

A main difference between the first embodiment and the embodiment of FIG. 2 is that the pushing magnets 5 and 6 are, related to the lens barrel 2, located on the opposite side compared to the locations of the the balls 20 of the ball bearings, pushing the lens barrel 2 onto the balls 20 of the bearings. No wings are required with the second embodiment.

It should be understood that the present invention could be applied not only to lens barrels but on any other movable parts of a camera or of any other appliance having movable parts, which are guided by ball bearings.

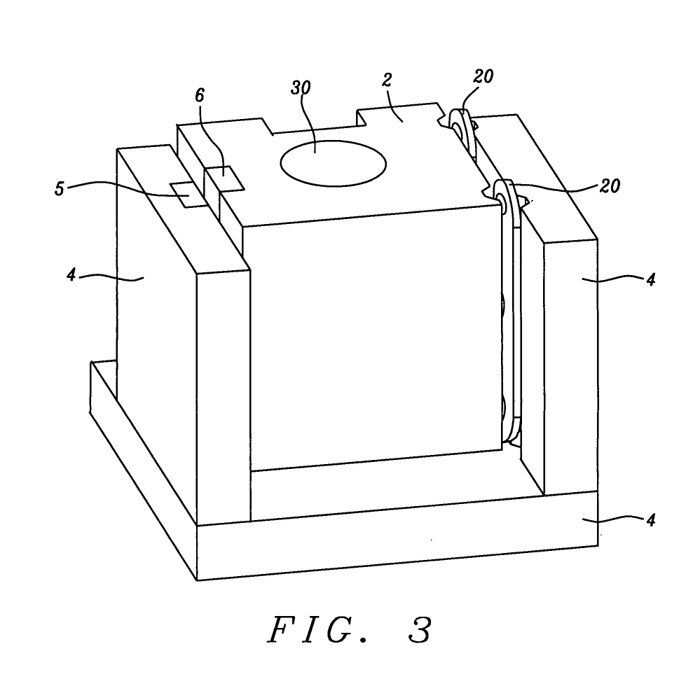

FIG. 3 shows an oblique 3-dimensional view of a camera module according to the second embodiment of the present invention, i.e. related to the lens barrel 2, the pushing magnets 5 and 6 are on the opposite side of the ball bearings. FIG. 3 illustrates It shows also a camera module 1, wherein a lens barrel 2 can be moved using the balls 20, having ball cages, of ball bearings. The lens barrel 2 can be moved to a focus position, e.g. by a motor of an autofocus system, along an optical axis of the camera, which is along a vertical axis of FIG. 3. The balls 20 are moving between a moving part, i.e. the lens barrel 2, and a fixed part 4 of the camera 1. By repulsive magnetic force the magnets 5 and 6 are pushing the lens barrel 2 onto the balls of the bearings.

Furthermore FIG. 3 shows an opening 30 of a lens/shutter system. The camera module invented furthermore comprises an integrated circuit (IC) controlling the actuators of the present invention, an image sensor, and a shutter that also can be used as an aperture. This IC also controls one or more motors with integrated position control to move shutter blades of the camera module as disclosed in the patent application DI08-006, titled “Camera Shutter and position control thereof”, Ser. No. 12/658,280, filing date Feb. 5, 2010.

It should be noted that other locations of pushing magnets are also possible. Alternatively more than one pair of magnets could be deployed depending also on a specific shape of the lens barrel.

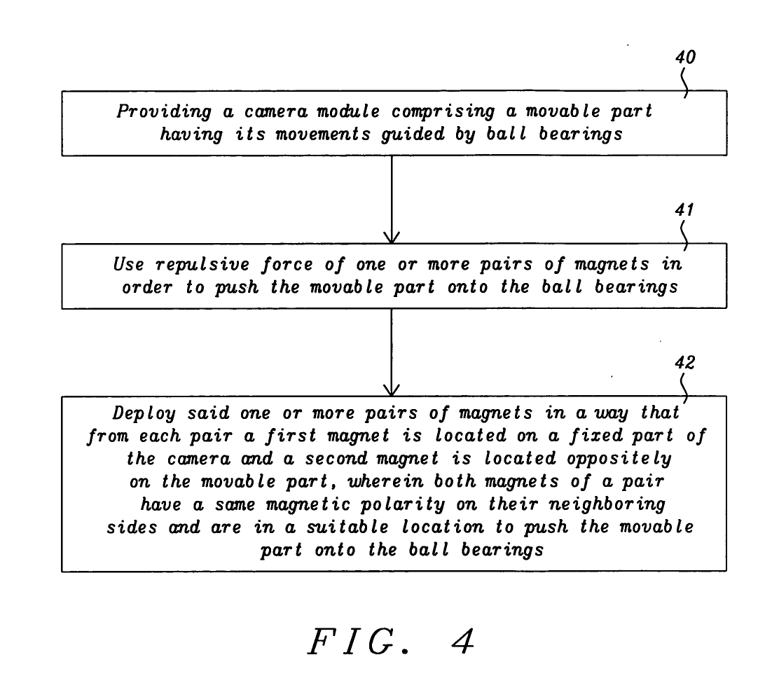

FIG. 4 illustrates a flowchart of a method for cameras to hold movable parts of the camera in place in case of a mechanical shock e.g. preventing balls of ball bearings falling out. A first step 40 illustrates a provision of a camera module comprising a movable part having its movements guided by ball bearings. Such a movable part could be for instance a lens barrel to be moved in a focus position. A second step 41 describes using repulsive force of said one or more pairs of magnets in order to push the movable part onto the ball bearings. The last step 42 of the method invented describes deploying said one or more pairs of magnets in a way that from each pair of magnets a first magnet is located on a fixed part of the camera and a second magnet is located oppositely on the movable part, wherein both magnets of a pair have a same magnetic polarity on their neighboring sides. Therefore the magnets apply a repulsive force against each other.

Another advantage of the present invention is that no electrical power during operation of the camera is required to hold the moving objects of the camera together because permanent magnets don't need electrical power.

While the invention has been particularly shown and described with reference to the preferred embodiments thereof, it will be understood by those skilled in the art that various changes in form and details may be made without departing from the spirit and scope of the invention.

What is claimed is:

1. A method for cameras to hold movable parts of the camera in place in case of a mechanical shock, comprising the following steps:
(1) providing a camera module comprising movable parts having their movements guided by ball bearings;
(2) using repulsive force of said one or more pairs of magnets in order to push the movable parts onto their ball bearings; and
(3) deploying said one or more pairs of magnets in a way that from each pair of magnets a first magnet is located on a fixed part of the camera and a second magnet is located oppositely on the movable part, wherein both magnets of a pair have a same magnetic polarity on their neighboring sides and are suitably located to push the movable part onto related ball bearings and hence preventing balls of the ball bearings to fall out and holding the movable parts in place.

2. The method of claim 1 wherein said movable part is a lens barrel.

3. The method of claim 1 wherein said movable part is a shutter system.

4. The method of claim 1 wherein said one or more pairs of magnets are located on a same side of the movable part as the ball bearings.

5. The method of claim 1 wherein said one or more pairs of magnets are located on an opposite side of the movable part to the ball bearings.

6. The method of claim 1 wherein said movable parts are moved linearly.

7. The method of claim 1 wherein movements of said movable parts comprise rotational movements.

8. A camera capable of holding movable parts of the camera in place in case of a mechanical shock, comprising:
an image sensor;
a shutter with an aperture function driven by a linear motor;
said motor driving the shutter, wherein the motor has an integrated position sensing system;
a movable lens barrel;
at least two actuators to move said lens barrel;
an integrated circuit controlling the motor driving the shutter and the actuators moving the lens barrel;
a first and a second magnet, wherein the first magnet is fastened on the moving lens barrel and the second magnet is deployed oppositely to the first magnet on a fixed part of the camera and wherein the first and the second magnets have a same magnetic polarity on their neighboring sides, hence pushing the lens barrel onto ball bearings; and
said ball bearings wherein the balls of each ball bearing are moving between the lens barrel and a fixed part of the camera.

9. A camera capable of holding movable parts of the camera in place in case of a mechanical shock, comprising:
a movable lens barrel;
a first and a second magnet, wherein the first magnet is fastened on the moving lens barrel and the second magnet is deployed oppositely to the first magnet on a fixed part of the camera and wherein the first and the second magnets have a same magnetic polarity on their neighboring sides, hence pushing the lens barrel onto ball bearings; and
said ball bearings wherein the balls of each ball bearing are moving between the lens barrel and a fixed part of the camera.

10. The camera of claim 9, wherein said first and second magnet are located on a same side of the movable part as the ball bearings

11. The camera of claim 9, wherein the lens barrel and the fixed part of the camera have both a shape to hold the balls of the ball bearings.

12. The camera of claim 9, wherein ball cages are used to secure the balls.

13. The camera of claim 9, wherein said first and second magnet are located on an opposite side of the movable part to the ball bearings.
